(19) United States
(12) Patent Application Publication
(10) Pub. No.: US 2024/0054567 A1
(43) Pub. Date: Feb. 15, 2024

(54) SMART UNDERWRITING SYSTEM WITH FAST, PROCESSING-TIME OPTIMIZED, COMPLETE POINT OF SALE DECISION-MAKING AND SMART DATA PROCESSING ENGINE, AND METHOD THEREOF

(71) Applicant: Swiss Reinsurance Company Ltd., Zürich (CH)

(72) Inventor: John TURNER, Zürich (CH)

(73) Assignee: Swiss Reinsurance Company Ltd., Zürich (CH)

(21) Appl. No.: 18/237,032

(22) Filed: Aug. 23, 2023

Related U.S. Application Data
(63) Continuation of application No. PCT/EP2022/063854, filed on May 23, 2022.

(30) Foreign Application Priority Data
May 21, 2021 (CH) 00575/21

(51) Int. Cl. G06Q 40/08

(52) U.S. Cl. CPC G06Q 40/08

(57) ABSTRACT

Proposed is a digital and automated underwriting system and method with fast point of sale decision-making and intelligent data processing engine for the coverage of possible damage impacted by the occurrence of health events to users. The automated system captures user-specific medical parameter data sets. The captured medical parameter data sets are processed by the electronic signal processing engine, wherein the electronic signal processing engine transmits an output signal generated upon processing the medical parameter data set, the output signal automatically triggering or blocking an automated underwriting process by an electronic underwriting unit.

### CROSS REFERENCE TO RELATED APPLICATIONS

The present application is a continuation application of International Patent Application No. PCT/EP2022/063854, filed May 23, 2022, which is based upon and claims the benefits of priority to Swiss Application No. 00575/21, filed May 21, 2021. The entire contents of all of the above applications are incorporated herein by reference.

### FIELD OF THE INVENTION

The present invention relates to automated underwriting (UW) systems. More particular, the invention relates to automated underwriting systems coping with the technical requirements of fast point of sale decision-making data processing operations. In general, the invention relates to digital underwriting systems for administering structured, parameter-based products such as defined health and/or life risk-transfer policies related to future occurrence probabilities of medical events associated with a risk-exposed individual (herein also referred to as applicant) for provide the technical requirements of fast point of sale decision-making data processing operations based on a reduced set of key data values. Further, the present invention is directed to automated, electronic UW and more generally risk-transfer (insurance) systems, particularly including UW systems methods providing optimized types of automated decision structure enabled to optimize technical system-design trade-offs, as e.g. accuracy versus coverage, accuracy versus interpretability, and/or run-time efficiency versus configuration-driven system architecture. In various aspects, it involves processing historical data, developing adaptive structures, applying those structures, updating those structures, and providing predictive pricing. However, automated UW and/or risk-transfer systems that use the present inventive methods and systems disclosed herein are not limited to health event coverage, disability coverage, both short term and long term, as well as term life risk-transfer systems, but may be generally applied in appropriate digital UW processes.

### BACKGROUND OF THE INVENTION

Automated decision-making systems have been deployed in many industrial and technical applications. The needs for such automated systems are usually motivated by requirements for variation reduction, capacity increase, cost and cycle time reduction, and end-to-end traceability of, of for example, a processed product or an automated transaction. Further, before an automated decision-making system can be used in a production or other industrial environment, further a strategy to ensure high quality throughout its entire lifecycle needs to be developed. Thus, its performance typically needs to be ensured through an appropriate adaption process which allows the system to react under changing environmental conditions. This process technically includes validation, tuning, and production testing of the system. Once the system is in operation its performance needs to be monitored and maintained over its lifecycle.

The technology used in automated decision systems comes from a broad base in the fields of computer technology and science. The information requirements and decision complexity handled by these techniques can vary widely depending on the application. Such applications can vary from common, repetitive automated transaction processing (such as an automated approval of purchases) to risk assessment and underwriting of complex risk-transfer structures and products. The selection of the supporting technologies depends on many factors, from pure data and information requirements (e.g. “Can the inputs be described in a metric space?”), to its output characteristics (e.g. “Is the output a discrete or continuous value?”), to technical design constraints and trade-offs that might prevent the use of specific technologies. Furthermore, the development of an automated decision engine typically is only the first step in a longer lifecycle process that covers the monitoring, updating, and maintenance of the automated operation of such engines.

In the development of any type of automated decision structure, we usually face several design trade-offs. Among the most common, there are: (1) accuracy versus coverage; (2) accuracy versus interpretability; (3) run-time efficiency versus configuration-driven architecture. Technically, these trade-offs are always present no matter what application of decision engine technology. In any phase of development, the technically skilled person based on the requirements of a specific application must be able to make the appropriate trade-off for that situation. This is particularly true for the construction of a process for an automated risk-transfer underwriting engine where each of these trade-offs needs to be determined and the application adapted accordingly based on predicted, simulated or otherwise forecasted future occurrence frequencies of impacting events, which forecast is typically highly sensitive to kind of measured and/or captured historic data.

The first trade-off in automated decision making is similar to the precision versus recall balancing found in the technical design of data/information retrieval systems. A classifier can be tuned to maximize its number of correct decisions, declining the degree of reliability about the conclusion. This technically increases the measured accuracy at the expense of coverage. Alternatively, the same classifier can be tuned to always issue a decision for each probe, increasing coverage at the expense of accuracy.

The second trade-off, sometimes also dictated by external requirements as even non-technical legal or compliance requirements (but producing a technical impact), constrains the underlying technologies used to implement the classifier. In some approaches, soft computing (SC) techniques are used, i.e. comprising a collection of computational structures (probabilistic, fuzzy, neural, and evolutionary) in which the relation “model=structure+parameters” takes a different impact, since a much richer repertoire can be applied to represent the structure, to tune the parameters, and to iterate the automated process. Whatsoever, the technical person skilled in the art must somehow choose among different trade-offs between the model's interpretability and its technical accuracy. For instance, one prior-art technical approach aiming at maintaining the modeling transparency starts by applying knowledge-derived linguistic modeling, in which domain knowledge is translated into an initial structure and parameters. The model's accuracy can then further be improved by using global or local data-driven or data-triggered search methods to tune the structure and/or parameters. An alternative prior-art approach aiming at building more accurate modeling structures, starts directly with data-driven search methods. Then, domain knowledge is embedded into the search operators to technically control or limit the search space, or to maintain the modeling processes' interpretability. Post-processing approaches are also sometimes used to extract explicit structural information from the modeling process. The third technical trade-off is related to the use of configuration adaptive files to drive the behavior of the classifiers, instead of hard-coding their logical behavior. The technical idea here is that the actual coded software implements a more generic approach structure to solving the problem, which then is specialized not within the code itself but by reading parameters from the adaptive configuration file. In fact, any external data source or real-world link, such as a database table or linked measuring or sensory devices, can be used to supply engine parameters, even by adapting them in real-time based on the real-world link. While slightly less efficient at run-time, the use of a common automated decision engine driven by adaptive configuration files produces a more maintainable classifier than one whose parametric values are intertwined in the engine's code. This additional computational cost can be justified for the purpose of lifecycle benefits.

The process of automated underwriting in risk-transfer applications technically involves all the discussed technical key issues in developing and deploying an automated decision engine thus being representative of the technically challenging classification problem. Automated risk-transfer, i.e. insurance, underwriting is a complex technical decision-making task that is traditionally performed by trained individuals for these reasons. An underwriter must evaluate each risk-transfer application in terms of its potential risk for generating a claim, such as mortality in the case of term life insurance. Risk as understood within this application is a physical measurand providing a measure for an occurrence probability or occurrence frequency of a physically and measurably impacting defined physical event to a defined real-world object or individual, the impact having an associated level of damage in a defined future time-window to the real-world object or individual. The level of impact can also be represented or measured by monetary amount equivalents. By measuring the actual occurring events and/or impacts in said future time-window, the accuracy of the forecasted probability can be technically measured and verified, respectively. In the prior-art, a risk-transfer application is compared against standards developed by the insurance company, which are derived from actuarial principles related to mortality. Based on this comparison, the application is classified into one of the risk categories available for the type of risk-transfer requested by the applicant. The accept/reject decision is also part of this risk classification since risks above a certain tolerance level will typically be rejected. The estimated risk, in conjunction with other factors such as gender, age, and policy face value, will determine the appropriate price (premium) for the insurance policy. When all other factors are the same, to retain the fair value of expected return, higher risk entails higher premium.

Structured, parameter-based products, i.e. risk-transfer (insurance) application) are generally based on or structured using a closed, finite input parameter space with are typically predefined and hold in what is also called health and/or life risk-transfer (insurance) policies or applications.

A risk-transfer (insurance) application is represented it the present disclosure as an input vector X̅ that contains a combination of discrete, continuous, and attribute variables and/or parameters. These variables represent the applicant's medical and demographic information/data that, in the prior art, typically has been identified by actuarial studies to be pertinent to the estimation of the applicant's claim risk measurand, i.e. the measurable probability for the occurrence of an impacting medial event to the applicant within a defined future time window. Similarly, within the present patent disclosure, the output space Y̅, e.g. the underwriting decision parameter space, as an ordered list of rate classes. Due to the intrinsic difficulty of representing risk measurands as absolute real number on a scale, e.g. 97% of nominal mortality, the output space Y can also e.g. be subdivided into bins (rate classes) containing similar risk measurand values. For example 96-104% nominal mortality could be labeled the standard rate class. Therefore, within the present patent disclosure, the underwriting process is considered as a discrete classifier mapping an input vector X into a discrete decision space Y̅, where |X̅|=n and |Y̅|=T.

Providing automated technical solutions to this problem is not straightforward due to several technical requirements: (1) The underwriting mapping is highly nonlinear, since small incremental changes in one of the input components or measured input parameters can cause large changes in the corresponding rate class; (2) Most input measurands or parameters require interpretations to be usable in automated data processing. Underwriting standards cannot explicitly cover all possible variations of a risk-transfer application, causing ambiguity. Thus the underwriter's subjective judgment will almost always play a role in this process. Variations in factors such as underwriter training and experience will likely cause underwriters variability in their decisions; (3) These interpretations require an intrinsic amount of flexibility of the technical data processing structure to preserve a balance between risk tolerance, necessary to preserve price competitiveness, and risk-avoidance, necessary to prevent overexposure to assessed risk; and (4) Legal and compliance regulations typically have technical implications since they require that the modeling structures used to make the underwriting decisions be transparent, interpretable, and provide a replicable operational accuracy.

To address these requirements, the UW decision structure can, inter alia, be extended by applying artificial intelligence (AI) or machine learning (ML) reasoning techniques, such as rule-based and case-based reasoning techniques, coupled with e.g. soft computing and data processing (SC) techniques, such as fuzzy logic and evolutionary processing structures. With such hybrid system, the herein proposed system is able to improve both flexibility and consistency of the inventive system, while maintaining interpretability and accuracy as part of the underwriting decision process and the digital risk-transfer management platform, as such.

It is to be noted that in the prior art risk-transfer technology of today, such electronic and/or digital automated UW processes become more and more important. There exist mobile applications, online websites, physical offices, call centers, and automated mail receival points all for the sale of risk-transfer options. However, there is no optimized, efficient, reliable and automatable risk-transfer processing, digital channel which permitted an applicant to get a risk-transfer product at a point of sale of a retailer or the like for an amount of cover or cover for a predetermined premium payable at said point of purchase, for a risk category predetermined by the risk-transfer/insurance system and stated on the product. There is a need for new technology providing similar operation for risk-transfer UW to existing technologies such as digital in-store purchases of software or music subscription services that must be activated in order to function. The addition, such an electronic, fast efficient-to-implement risk-transfer UW channel would streamline the risk-transfer/insurance procurement process by integrating automated insurance technology into the fast-moving consumer goods sector, an area devoid of tangible financial service products.

The prior art document US 2019/0180379 A1 discloses an electronic, real-time mortality classification and signaling system for real-time risk assessment, and adjustment based on an automated selective multi-level triage process. The signaling is used for automated transfer of risks associated with a plurality of risk-exposed individuals from a risk-exposed individual to a first insurance system and from the first insurance system to an associated second insurance system. The mortality classification and signaling system accesses a database stored in a memory to retrieve risk classes, identifies and selects a specific risk class associated with the risk of the exposed individual, processes specific parameters of the exposed individual using a machine learning-based pattern recognition to automatically assign risk-exposed individuals with detected non-smoking patterns to a second triage channel, and automatically assigning risk-exposed individuals with detected smoking patterns to a third triage channel as predicted smokers. Based on the classified risk, the system provides an alert notification to a third-party system, if an attempted underwriting fraud is detected. Further, the prior art document US 2002/0111835 A1 discloses an automated underwriting process, in particular for life risk-transfer. The process of automated underwriting comprises a rule-based process from a plurality of risk-transfer carriers. Rules can be general, carrier specific, and product specific. Also featured is an automated reflexive process for questioning a user that is purchasing a risk-transfer. The process at least comprises (i) receiving a first set of information about a user; (ii) displaying a first range of pricing information for a life insurance plan for the user to the user; (iii) receiving a second set of information about the user; displaying a second range of pricing information for the life insurance plan to the user; (iv) receiving quotes for the life insurance plan from a plurality of risk-transfer carriers; and (v) displaying the quotes in form of generated pricing parameters to the user.

### SUMMARY OF THE INVENTION

It is an object of the invention to provide an automated underwriting system with fast, processing-efficient, point of sale decision-making and intelligent data processing engine allowing for systematic capturing, measuring, quantifying, and forward-looking generating of appropriate risk and risk accumulation measures of physical humans. Further, it is an object of the invention to provide a new, efficient, and fast UW process for the automation of an UW process for health risks based on limited data capturing by delivering point of sale decisions in return. The automated system should be usable to automatically and efficiently generate appropriate premiums and underwriting policies specifically adapted to a certain risk appetite of an insurer, in particular by having only access to limited data processing power.

It is a further object of the invention to provide an optimized structure for the automation of the underwriting process in particular to allow an extended and faster processing of underwriting requests, i.e. to contemplate a computer-implemented processing-efficient process of developing an automatable person-level cost modelling structure. Based on the inventive use and development of universe data, inter alia through the application of an interaction capturing technique, the invention allows to capture 90 to 95% of all underwrite applications reducing the necessary technical data processing time and CPU time by a factor of 1000 and more. It is important to understand that the present decision-tree structure is directly linked to the herein proposed efficient cost forecasting modelling and simulation structure, not intending to cover all possible kinds of underwriter characteristics and constellations but limiting the processed underwriter application by a precise and technically controllable digital decision-tree triage process conducted by solely electronic means. The invention allows to provide, inter alia, a computer-implemented, deterministic, decision-tree-based process wherein the interaction capturing technique can be selected from decision-tree techniques as median regression tree techniques, least square regression tree techniques, rule induction techniques, ordinary least squares regression techniques, median regression techniques, robust regression techniques, genetic algorithms, rule induction, clustering techniques and neural network techniques. Thus, the invention is automated optimized and adjusted by applying the mentioned machine-learning structures. The inventive technical solution can be further optimized by adjusting the person-level next period risk and/or cost forecasts by modifying the extant risk and/or cost forecast by the measured and/or simulated expected risk and cost trend, respectively. Thus, it is a further object of the invention to provide an adaptable technical decision and forecast simulation structure which is optimizable and improvable by machine-learning-based means, wherein the automated simulation and forecast, respectively, is based on the simulated forecast based on measured occurrence of medical event frequencies, i.e. the measured and predicted forecast of measuring values providing a physical measure for the occurrence rate (frequency) of medical events based on the measured or captured characteristics of a medical individual of a cohort of individuals.

It is important to note, that the term “risk”, “risk measure” or “risk measuring parameter” in particular “risk index parameter”, is explicitly understood within this patent disclosure as a technical measurand providing a technically reproducible measuring value within a measuring error for a future occurrence frequency of a physically impacting measurable and physical measurable medical event to an applicant/individual. In particular, the medical event can be real world medical events such as heart attack/angina pectoris, cancer, diabetes, epilepsy, anemia, and/or leukemia etc., which are measurable and clinically or medically detectable and traceable by tacking respective laboratory value or diagnostic measurand. Therefore, the term “risk”, as used in the present patent disclosure, is a technical measurand and has nothing to do with an estimated or cognitive placeholder achieved by a human expert, as a cognitive-estimated risk assessment, as it is sometimes used in pure business model processes. In the present invention, a human-based business-oriented interaction shall explicitly be exclude, wherein the invention is realized, automated and operated exclusively by technical means, in particular technical, electronic means and signal processing devices/systems.

According to the present invention, these objects are achieved particularly through the features of the independent claims. In addition, further advantageous embodiments follow from the dependent claims and the description.

According to the present invention, the abovementioned objects are particularly achieved by the digital, automated underwriting (UW) system and method with an optimized, decision-tree-based electronic signal processing engine for the coverage of possible damages impacted by the occurrence of one or more medical events to an applicant, in that the coverage is provided by applying a risk-transfer structure of an associated risk-transfer system to the applicant, wherein user-specific medical parameter data sets are captured and/or measured by associated capturing or measuring devices via data interfaces of the automated UW system, wherein each captured medical parameter data set is processed by the electronic signal processing engine, the electronic signal processing engine transmitting an output signal generated upon processing the medical parameter data set by decision-tree-based structure, and the output signal automatically triggering or blocking an automated application of the risk-transfer structure upon electronic signal transfer to the risk-transfer system, in that medical events of a historical event database having a similar risk shape pattern are clustered and linked together, wherein similarity of risk shape pattern is given if the risk shape pattern of said medical events are detected to be within a defined maximal topological distance within a parameter space given by a medical parameter datasets of a medical event, in that risk shape pattern are extracted at least based on occurrence frequency and impact severity measured based on measured occurrences of the medical events of the historical database, and in that the linking of medical events of said historical event database to a same cluster is provided by a set of linking rules and/or linking questions forming a decision-tree-based data processing structure of the electronic signal processing engine, wherein a decision distribution given by outputted decisions provided by applying the decision-tree-based data processing structure electronic signal processing engine represents the frequency of medical events measured to be within the same cluster of risk shape pattern. The invention has, inter alia, the advantage, that it requires/produces no medical evidence costs or manual underwriting referrals. For most risk assessments (90-95%), the simplified process provides a good enough decision, though using only simple clinical data the applicants typically know about themselves. If a main disorder is indicated by the captured data, the solution uses only 2-5 simple further questions per main disorder and no precise diagnosis is needed. Compared to other more complex rule-based prior art automated UW solutions and processes, the invention is based on only approximately 100 to 200 rules, while the more complex prior art systems typically need to rely on 20'000 rules and even more.

In an embodiment variant, the number of linking rules and/or linking questions of the set can be adapted and/or reduced and/or increased, in particular dynamically by the system, until a minimal set of linking rules and/or linking questions capture a predefined percentage of processed medical parameter data set with an output signal that automatically triggers the automated application of the risk-transfer structure of the risk-transfer system. The predefined percentage can e.g. be equal or above 65% of the number of the processed medical parameter data set. The predefined percentage can e.g. also be equal or above 95% of the processed medical parameter data set. A cluster of medical events of a historical event database having a similar risk shape pattern comprise related and/or unrelated medical event, wherein unrelated medical events at least comprise medical events with unrelated clinical pictures and/or unrelated medical causes. By detecting and/or measuring newly occurring medical events not culsterable by the set of linking rules and/or linking questions of the decision-tree-based data processing structure due to a missing similarity to existing risk shapes pattern, additional linking rules and/or linking questions dedicated to capture and cluster the newly occurring medical events can e.g. be generated and added to the set of linking rules and/or linking questions. In particular, new risk shape pattern can e.g. be dynamically recognized by a machine-learning and/or AI-based module, i.e. dynamically recognizing new risk shape pattern by pattern recognition and comparing or mapping each new risk shape pattern to existing risk shape pattern. If no exiting cluster can be triggered by the measured similarity of the new risk shape pattern with the existing ones, the process of generating additional linking rules and/or linking questions is initiated by the system. The signal processing engine can e.g. provide automated, fast point of sale decision-making based on an adaptive data capturing.

In another embodiment variant, first level branches of the decision-tree structure applied during data processing by the signal processing engine can e.g. comprise a threefold rule-based triage-process, the medical parameter data sets being triaged by applying a first rule-based trigger triggering off a first trigger-flag upon detection of medical parameter values in a processed medical parameter data set indicating an predicted damage to the user based on an occurrence of heart disease event, cancer event or diabetes event, and by applying a second rule-based trigger triggering off a second trigger-flag upon detection of medical parameter values in the processed medical parameter data set indicating an occurrence of two or more consecutive weeks off work due to sickness or injury in the past 12 months, and by applying a third rule-based trigger triggering off a third trigger-flag upon detection of medical parameter values in the medical parameter data set indicating an admission of the individual to a hospital at any time in the past two years, in that upon detecting that none of the three trigger-flags being triggered by the system, the processed medical parameter data set is assigned to the automated underwriting process by generating and transmitting the output signal by the electronic signal processing engine to the electronic underwriting unit of the digital UW system, the output signal automatically triggering the automated underwriting process of the electronic underwriting unit, and in that upon detecting that at least one the three trigger-flags being triggered by the system, the triggering of the automated underwriting process is rejected by the system at the first level branches of the applied decision-tree structure for the processed medical parameter data set. This embodiment variant has, inter alia, the same advantages the previous one. It is to be noted that the above-described threefold rule-based triage-process based on the sequence of decisions following the triaging three questions detailed here (i.e. heart disease, diabetes, time off work/hospital admission) are just an example of an embodiment variant of a typical simplified health decision-tree. They do not need to be themselves part of the inventive system 1, but any positive answer to this threefold rule-based triage-process, or indeed any other health question, can automatically trigger reflex rules and/or linking questions contained within process of the inventive system 1. As an aside, the ability to quantify any response values, as is provided in or by using the inventive system 1, access/underwriting can e.g. fundamentally shift some of the earlier mentioned trade off compromises, as implemented in the process of the system 1, in that the system 1 applies very sensitive questions, such as “Have you consulted a doctor in the last 12 months?” but still quantify all disclosures at point of sale. This facilitates quite a radical change of simplified automated health questionnaire linking structure which is not normally possible without triggering the system 1 to cut of too many applicants by the automated underwriting process.

As an embodiment variant, second level branches of the applied decision-tree structure are applied by the signal processing engine to a processed medical parameter data set, if the triggering of the automated underwriting process is rejected by the system for said processed medical parameter data set, and the second level branches are driven by a supplement medial response process, the supplement medial response process comprising capturing of a limit set of user-specific health data detailing out the processed medical parameter data set based on the possible indications of at least heart disease and/or cancer and/or diabetes and/or epilepsy. The limited set of user-specific health data can e.g. be captured by an intelligent hierarchical input tree adapting subsequent of user-specific health data request based on user-specific health data precedingly captured. In case of detecting an indication of epilepsy in a processed medical parameter data set, the intelligent hierarchical input tree can e.g. comprise in a first tree structure a request for user-specific health data indicating a time of first diagnosis of epilepsy and a time of last diagnosed epilepsy attack, and in case of detecting a diagnosed epilepsy attack within the last 12 month, in a second tree structure a request for user-specific health data indicating a hospital stay caused by a diagnosed epilepsy attack and/or a number of epilepsy attacks within the last 12 month and/or at least one grand mal epilepsy attack.

In a further embodiment variant, the capturing of the medical parameter data set and the supplement medial response process can e.g. be realized based on the IDC (International Data Corporation) integration. The data requests from to the user over a data interface can e.g. be realized by a digital communication plugin integration providing seamless data integration. The IDC integration has, inter alia, the advantage that it allows supply of content for the UW questionnaires, yet styling capabilities offered to make integration seamless for the end user, while taking full advantage of IDC business logic functionality.

In a preferred embodiment variant, the UW system can e.g. base the UW decisions outputted by the system 1 on definable life guide main risk variables, which can e.g. be extracted using historical clinical parameter values or aggregations per disease. However, in another embodiment variant, the UW system can also e.g. comprise machine-learning based process for developing a user-specific damage modelling structure for automated forecasting of future health damage measures, wherein an automated forecast of a future health damage measures is for an actual or future time period, comprising the steps of: (A) providing development of a dynamically adapted integral database based comprising user-specific underwriting data and historical medical/health data, which can e.g. also comprise historical impact and/or damage and/or health care claims, where the historical medical/health data can e.g. comprises at least an applicant or claim code and an applicant or claim or damage amount; (B) providing at least one forecasted damage factor for each historical base period damage or claim based on the applicant/claim code associated with the medical/health damage/claim value and providing at least one forecasted damage factor based on the underwriting data; and (C) developing the user-specific damage modelling structure simulating a predictive impact measure of a damage associated with the occurrence of the health event to the user based on the dynamically adapted integral database through the application of an interaction capturing technique to the dynamically adapted integral database. The machine-learning based process can e.g. comprise at least one interaction capturing technique selected from a group consisting of median regression tree techniques and/or least square regression tree techniques and/or rule induction techniques and/or ordinary least squares regression techniques and/or median regression techniques and/or robust regression techniques and/or genetic algorithms, rule induction and/or clustering techniques and/or neural network techniques. Values of the future health damage measures can e.g. be simulated by modifying an extant cost forecast value by simulating expected cost trend values. The datum from historical claims used as predictors can e.g. consist essentially of the claim- and underwriting-based probability factors, wherein a damage amount value is a standardized cost value of health services provided, and wherein prospective payments are allocated to health care providers by the user-specific damage modelling structure. Data from the historical health care claims data can e.g. be used as input the user-specific damage modelling structure comprise essentially the claim code and selected mandatory procedures, wherein a claim amount value is measured as a standardized cost value of health services provided during the same time period as a base period and wherein an efficiency factor of health care providers is generated by the user-specific damage modelling structure. The forecasted future health damage measures only can e.g. comprise damage measures attributable to claims from a user. The actual or future time period can e.g. be associated with a defined term of a risk-transfer between the user and an automated risk-transfer system, the automated risk-transfer system covering a probability of the occurrence of a damage impact to the user in return of accumulating resources of a plurality of users. This embodiment variant hast, inter alia, the advantage that the digital UW system provides an automated machine-learning based process for developing a user-specific damage modelling structure for automated forecasting of future health damage measures usable as basis for electronic UW processes and process control.

As an even further embodiment variant, the signal processing engine can e.g. provide fast point of sale decision-making based on an adaptive data capturing. This embodiment variant has inter alia the same advantages as the previous embodiment variants. In particular, a technical advantage is given by the uniqueness of the present invention delivering point of sale decisions to all in an efficient, reliable, and low-cost manner compared to the complex automated prior art UW systems. The present invention is able to provide a game changing automation of the underwriting process with the power to significantly reduce the required technical effort. Prior art simplified and/or automated underwriting processes typically excluded up to 40% of potential applicants. The present invention solves that problem in a straight-forward technically efficient way and a low-cost manner. In particular, it provides quick and easy implementation, it provides appropriate risk and fair decision making based on automated processes, and it causes zero medical evidence costs or manual underwriting referrals.

### BRIEF DESCRIPTION OF THE DRAWINGS

The present invention will be explained in more detail below relying on examples and with reference to these drawings in which:

FIG. 1 shows a block diagram, schematically illustrating the inventive, technologically simplified UW process, where the left side illustrates the basic system and process and the right side an innovative extension to the system.

FIG. 2 shows a diagram, schematically illustrating a reduced 2-cycle decision process based on intelligent rules adapting the second cycle decision to the previous input answer data of the first decision cycle (avoiding pointless long journeys for the majority).

FIG. 3 shows a block diagram, schematically illustrating the operating scheme and structure. The system inter alia provides a pooled reporting facility for rule maintenance needs.

FIG. 4 shows a diagram, schematically illustrating the IDC (International Data Corporation) capabilities of the present invention.

FIG. 5 shows a block diagram, schematically illustrating an embodiment of the inventive system. For medical events of “angina”, in the prior art, the risk assessment would normally be based on many variables which the applicant would not know, such as which vessels were affected and by how much. In contrast, the inventive system uses proxies for the severity which an applicant is able to answer, such as returned to normal activities (those with more severe angina are less likely to be able to continue to work as they did previously). Not included in the reflex questions is some hidden risk relevant factors fed directly from the application form, in this case smoker status and age, both of which result in a different decision for each subtype of angina.

FIG. 6 shows a block diagram, schematically illustrating an embodiment of the inventive system. Similarly to the embodiment variant, discussed under FIG. 5, for leukemia, there are several different subtypes, each of which has a very different risk severity and shape. Here, the linking rules and/or linking questions, extracted by the system 1, ask the applicant to select the type (most would know this), and trigger reflex questions most appropriate to each type (e.g. chronic leukemia, the system 1 does not ask about remission, but for acute, the system does).

FIG. 7 shows a block diagram, schematically illustrating an embodiment of the inventive system capturing finally a usually milder condition, but one which does have more significant types, but rather than asking the applicant to give what might be a very clinical name, the system uses number of medications as a proxy for disease severity for the linking rules and/or linking questions.

FIG. 8 shows a diagram, schematically illustrating an embodiment of an inventive automated matching and assigning process of a detected and clustered risk shape to pricing parameter values. FIG. 8 articulates and shows the automated pricing process of the underwriting process and the technical role of the UW system 1 to automatically match, as closely as possible, a variably adjusted pricing to an applicant's risk (bottom axis is worst to best risks). It is to be noted that there will always be a small percentage who is not applicable by underwriting at an affordable price (those let of the dotted line). The theoretical flat pricing is not relevant for voluntary risk-transfers but would be for an obligatory social type of risk-transfer, where there is no choice of purchase.

FIG. 9 shows a diagram, schematically illustrating the same process as FIG. 8 in a different way, with typically standard pricing processes defining the standard price based on fixed risk factors (age, policy type, term, etc.) and an extended underwriting process assessing each applicant/individual to identify if they qualify for that standard pricing based on individual variables (primarily personal medical history or state of health) specific for a certain extended underwriting process. These so-called loadings are typically based on relative risk values to the defined standard price of the standard pricing process, so e.g. a standard price might be X, but a loaded premium could be 2 times X, or 3.5 times X, but the same multiple might be applied for many different medical conditions, e.g. 2 times X might be due to any of obesity, hepatitis or high blood pressure (for example). This processing in multiple of standard pricing, typically called “extra mortality” for life risk-transfer/insurance structures, forms the basis of how the inventive system 1 can, for example, be realized to automatedly assessing those additional medical risks; the system 1 captures each applicant's input/disclosure and identifies if that disclosure is a not important factor which can be immediately placed into the standard price category, or the system 1 identifies disclosures which might be of higher risk values and requests input to reflex questions to identify the most appropriate risk category, including still standard, or also multiples of standard or even declinature in some cases if the risk value is detected to be too high to be insurable. Some medical conditions require very specific linking questions to quantify the level of additional risk, i.e. to cluster it to the correct risk shape, such as obesity which is driven primarily based on current height and weight, and these would have bespoke rules built into to present inventive system 1. Related disease pattern can often be grouped/clustered together, for example, very differing moderate blood disorders, such as hemophilia and thrombocythemia, which if not awaiting investigations or hospital treatment show a relatively fixed extra mortality multiple. But beyond this, other, even very different, conditions can have their level of additional risk quantified using the same reflex linking questions. An example of a common linking rule for differing conditions might be rabies and an unexplained syncope (faint), both of which can be assessed in the same manner, with a short postpone period followed by standard rates if fully recovered.

### DETAILED DESCRIPTION OF THE PREFERRED EMBODIMENTS

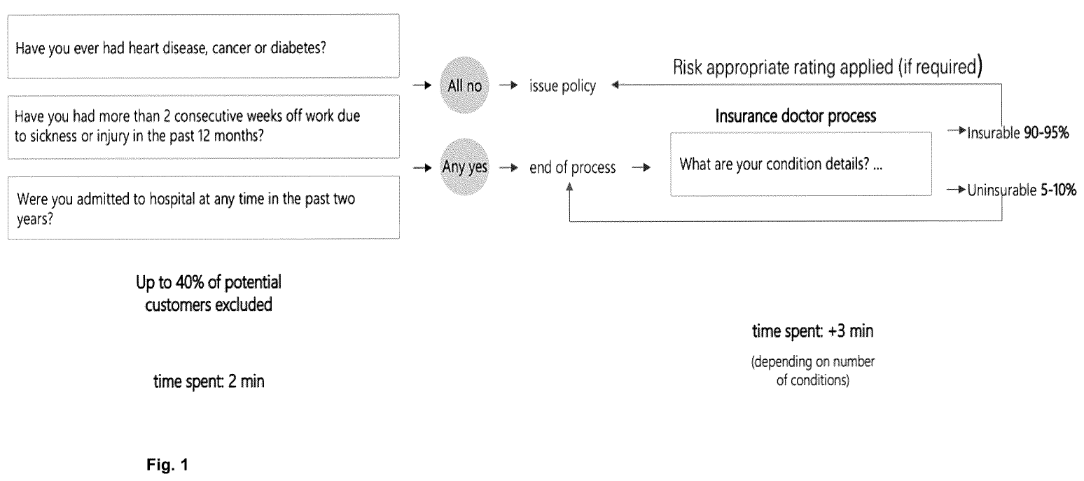

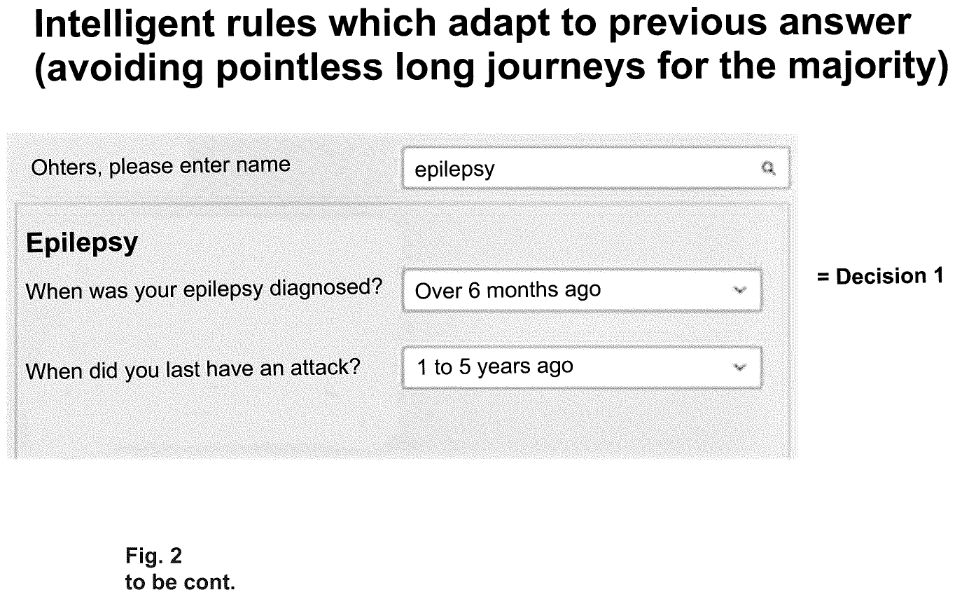

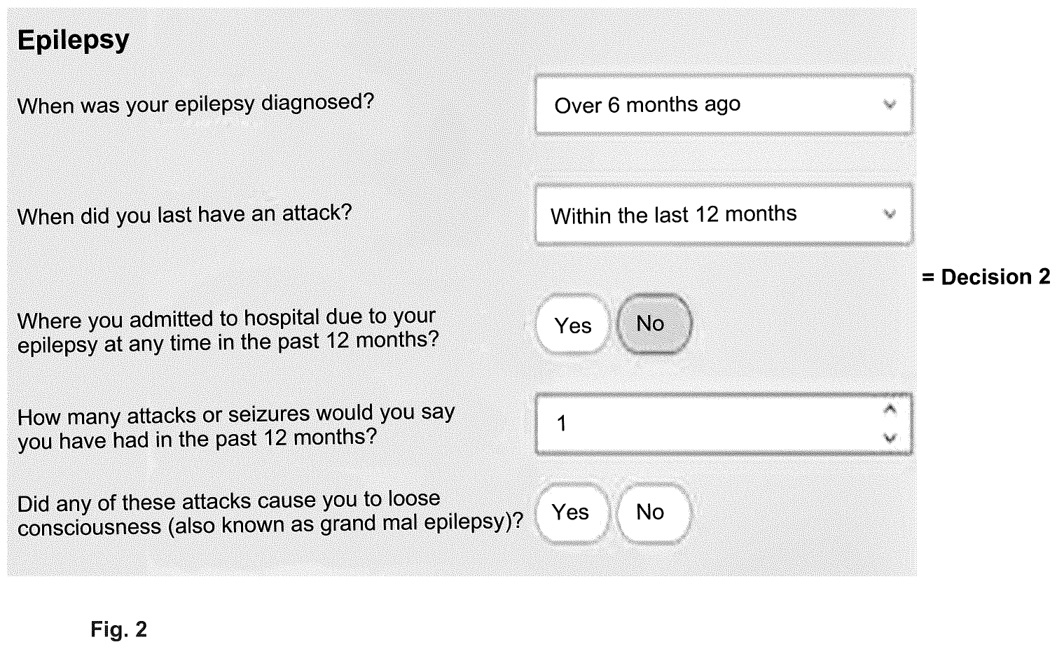

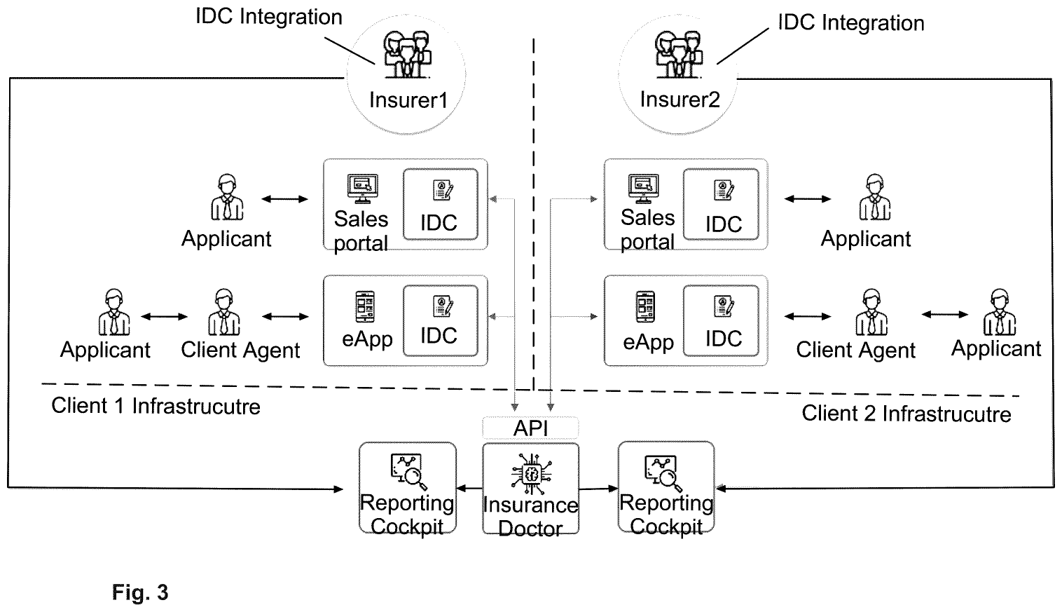

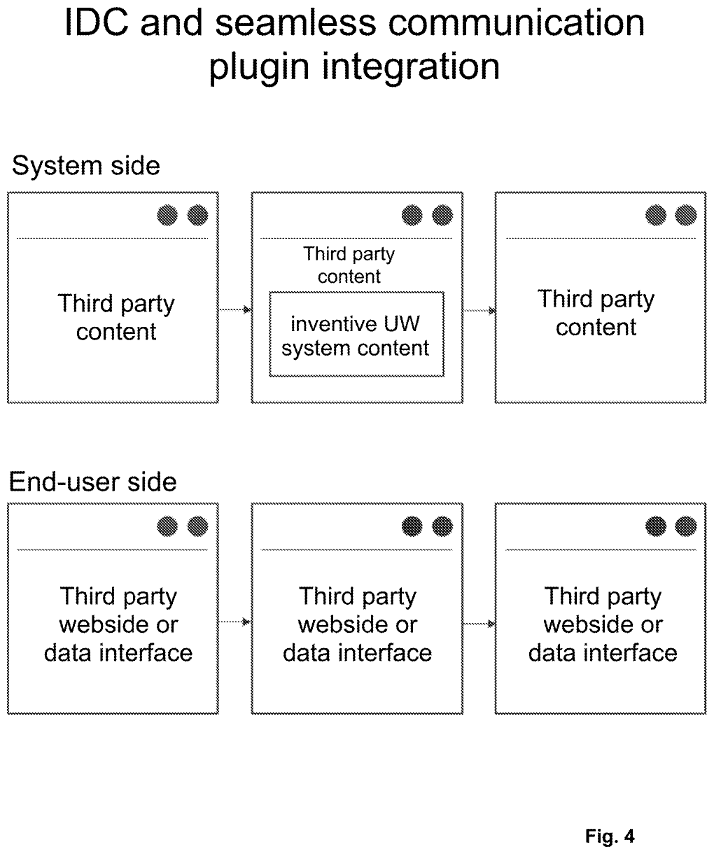

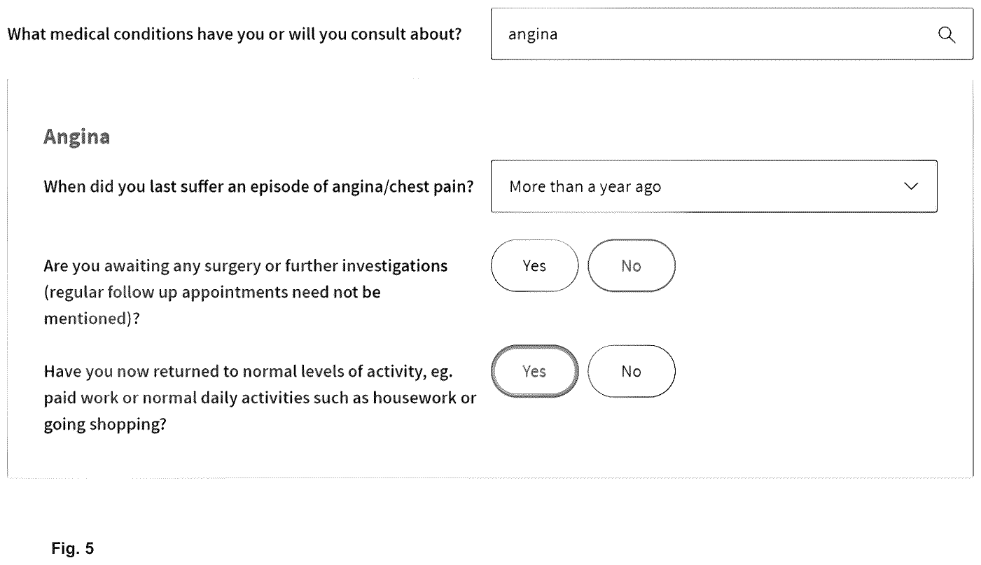

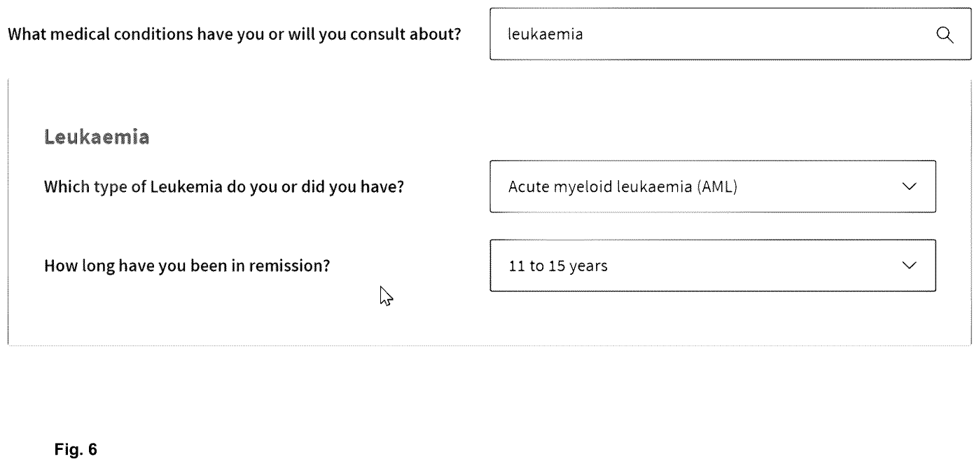

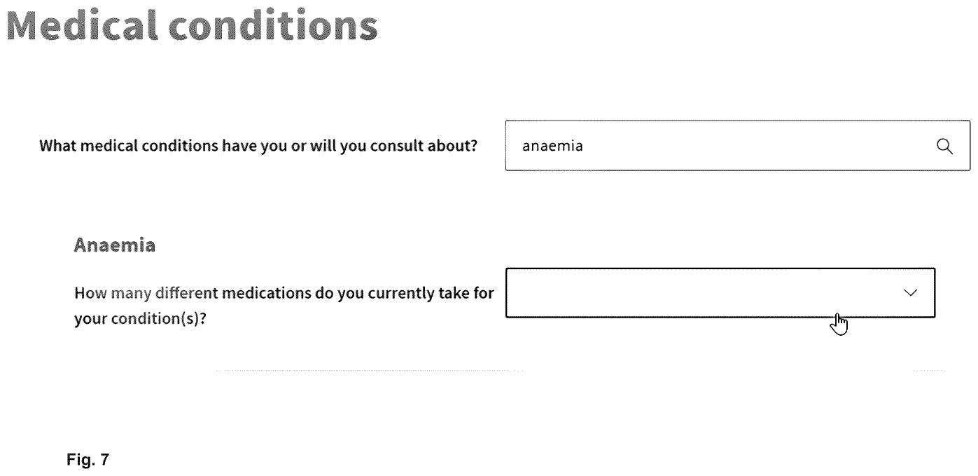

FIGS. 1-9 schematically illustrate an architecture for a possible implementation of an embodiment of the inventive digital, automated underwriting (UW) system 1 for an automated underwriting system with fast point of sale decision-making and smart data processing engine.

The digital, electronically driven, automated UnderWriting (UW) system 1 with an optimized, decision-tree-based electronic signal processing engine 11 for the coverage of possible damages impacted by the occurrence of one or more medical events to an applicant of the automated underwriting system 1.

The term “automated underwriting”, as used herein, is understood as the process where electronic means, as e.g. computer means provide a robotic process automation, inter alia using e.g. machine learning and/or artificial intelligence (AI) means, provide a processing of measurand and/or parameter and/or other information data associated with an applicant to automatically map, recognize and underwrite a potential of having an impact by a real-world impacting event to the applicant (i.e. risk of potential) for a future time window. The completed underwriting process typically triggers the coverage of the impact to the applicant in the future time window by a risk-transfer system associated with the underwriting process. Advanced systems may also use AI and machine learning (ML) to measure/evaluate risk measures, trigger how much coverage the applicant receives, and how much monetary resources the applicant must transfer to balance the risk coverage by the risk-transfer system.

It is to be noted, that while the automated risk-transfer underwriting of the present inventive system can be completed quickly and/or energy and computing power efficient and/or working on a reproducible technical bases using the inventive smart decision-tree structure to automate the assessment of an applicant's risk shape profile and/or health history, manual underwriting is the exact opposite. Manual business-related insurance underwriting takes much longer to complete and involves the intrinsic chance of human errors, as it depends on a person to assess an applicant's risk shape profile. In addition, human underwriters typically require a great deal of paperwork, like bank statements, tax returns, proof of employment, medical history, demographic profile, and more. Once the applicant is able to obtain and provide the underwriter with this information, the underwriter then needs to assess the potential risk in providing risk-transfer to the client. While manual underwriting can be an option for applicants with unique situation, for most of the applicants, such an extensive assessment is not needed but for the risk-transfer provider, it's a drain on time and resources. A risk shape and a risk shape pattern of an applicant can be complex and depend on the identification of the used measuring parameters and risk measurand factors. The risk shape parameters can e.g. be classified into six groups: biological, chemical, physical, psychosocial, personal, and other parameters. The association between potential health outcomes and health risk factors can be part of a dynamic automated process of the automated UW system 1, or predefined and implemented into the structure of the system. For automated identification and classification of the used health risk factors and their parameters can also be realized on the basis of pattern recognition applied to medical and clinical datasets. Again it has to be noted, that the term “health risk”, within this application, is used to denote a technically measurable measurand or measuring parameter quantifying the impact of a possible occurrence of a medical event causing measurable harm to an applicant's health status. Thus, the term “risk” or “health risk”, used herein, denotes the measurable probability or likelihood of harmful effects to a human/applicant's health or to ecological systems resulting from exposure to various external and internal stressors. Therefore, an applicant's health risk can also be denoted as the measurable likelihood that a given real-world exposure or series of exposures have damaged or will damage the health of an applicant/individual. The risk shape denotes the measurable parameter value pattern of the health risk factors associated with an applicant's measurable health status, wherein the health status denotes the parameter value pattern at a certain time.

In the present invention, the coverage is provided by applying a risk-transfer structure of an associated risk-transfer system to the applicant. The risk-transfer system is an automated risk-transfer system which can be e.g. electronically triggered by electronic signal transfer from the automated UW system 1, which out any human interaction. User-specific medical parameter data sets are captured and/or measured by associated capturing or measuring devices 121 via data interfaces 122 of the automated UW system 1. Each captured medical parameter data set is processed by the electronic signal processing engine 11, wherein the electronic signal processing engine 11 transmits an output signal generated upon processing the medical parameter data set by decision-tree-based structure. Upon electronic signal transfer, the system generated and transmitted electronic output signaling automatically triggers or blocks an automated application process of the risk-transfer structure to the electronically connected risk-transfer system.

Medical events of a historical event database having a similar risk shape pattern are clustered and linked together, wherein similarity of risk shape pattern is given if the risk shape pattern of said medical events are detected to be within a defined maximal topological distance within a parameter space given by a medical parameter datasets of a medical event. Risk shape pattern are extracted at least based on occurrence frequency and impact severity measured based on measured occurrences of the medical events of the historical database. A cluster of medical events of a historical event database can e.g. have a similar risk shape pattern for all medical events of the same cluster comprising related and/or unrelated medical event, wherein unrelated medical events at least comprise medical events with unrelated clinical pictures and/or unrelated medical causes. By detecting and/or measuring newly occurring medical events not culsterable by the electronic signal processing engine 11 and its set of linking rules and/or linking questions of the decision-tree-based data processing structure, respectively, due to a missing similarity to existing risk shapes, additional linking rules and/or linking questions dedicated to capture and cluster the newly occurring medical events are generated and added to the set of linking rules and/or linking questions.

The clustering of the medical events of a historical event database can e.g. be done using unsupervised learning structures. In addition, using and applying supervised learning structures to the clustered medical events of a historical event database can then be used to classify the clusters based on their associated risk shape profile and map or evaluate their corresponding risk measurand values.

To realize the decision-tree based automated UW process, the linking of medical events of said historical event database to a same cluster is provided by a set of linking rules and/or linking questions forming a decision-tree-based data processing structure of the electronic signal processing engine 11. A decision distribution given by outputted decisions provided by applying the decision-tree-based data processing structure electronic signal processing engine 11 represents the frequency of medical events measured to be within the same cluster of risk shape pattern. The number of linking rules and/or linking questions of the set can e.g. be adapted and/or reduced and/or increased until a minimal set of linking rules and/or linking questions capture a predefined percentage of processed medical parameter data set with an output signal that automatically triggers the automated application of the risk-transfer structure of the risk-transfer system. As an embodiment variant, said predefined percentage is equal or above 65% of the processed medical parameter data set. In particular, said predefined percentage can e.g. be selected to be equal or above 95% of the processed medical parameter data set. For example, the digital system 1 and method, at least partially realized as/with the new automated UW system, can e.g. provide a new simplified UW process for the automation of an UW system for health risks based on very few, e.g. 3 to 5, simple linking questions by delivering point of sale decisions in return. The invention can also be used to automatically generate appropriate premiums and underwriting policies specifically adapted to a certain risk appetite of an insurer (see FIG. 1).

The digital, automated underwriting (UW) system 1 comprises a self-optimizing, hierarchical multi-level decision-tree-based electronic signal processing engine 11 for the coverage of possible damage impacted by the occurrence of health event to users, i.e. underwriters accessing the automated underwriting process of the UW system 1. User-specific medical parameter data sets are captured and/or measured by associated measuring or capturing devices 121 and/or data interfaces 122 of the automated UW system 1. Each captured medical parameter data set is processed by the electronic signal processing engine 11. The electronic signal processing engine 11 transmits an output signal generated upon processing the medical parameter data set. The output signal automatically triggers or blocks an automated underwriting process by an electronic underwriting unit 13 of the digital UW system 1 by electronic signal transfer to the electronic underwriting unit 13. In particular, the UW system 1 and its signal processing engine can e.g. provide fast point of sale decision-making based on an adaptive data capturing.

In an embodiment variant, first level branches of the decision-tree structure applied during data processing by the signal processing engine 11 can e.g. comprise a threefold rule-based triage-process, wherein the medical parameter data sets is triaged by applying a first rule-based trigger triggering off a first trigger-flag upon detection of medical parameter values in a processed medical parameter data set indicating an predicted damage to the user based on an occurrence of heart disease event, cancer event or diabetes event. By applying a second rule-based trigger triggering off a second trigger-flag upon detection of medical parameter values in the processed medical parameter data set indicating an occurrence of two or more consecutive weeks off work due to sickness or injury in the past 12 months, and by applying a third rule-based trigger triggering off a third trigger-flag upon detection of medical parameter values in the medical parameter data set indicating an admission of the individual to a hospital at any time in the past two years. Upon detecting that none of the three trigger-flags being triggered by the system 1, the processed medical parameter data set is assigned to the automated underwriting process by generating and transmitting the output signal by the electronic signal processing engine 11 to the electronic underwriting unit 13 of the digital UW system 1, the output signal automatically triggering the automated underwriting process of the electronic underwriting unit 13. On the other side, upon detecting that at least one the three trigger-flags being triggered by the system 1, the triggering of the automated underwriting process is rejected by the system 1 at the first level branches of the applied decision-tree structure for the processed medical parameter data set. If the triggering of the automated underwriting process is rejected by the system 1 for said processed medical parameter data set, second level branches of the applied decision-tree structure are applied by the signal processing engine 11 to a processed medical parameter data set. The second level branches are driven by a supplement medial response process, the supplement medial response process comprising capturing of a limit set of user-specific health data detailing out the processed medical parameter data set based on the possible indications of at least heart disease and/or cancer and/or diabetes and/or epilepsy. The limited set of user-specific health data are captured by an intelligent hierarchical input tree adapting subsequent of user-specific health data request based on user-specific health data precedingly captured. In that in case of detecting an indication of epilepsy in a processed medical parameter data set, the intelligent hierarchical input tree comprises in a first tree structure a request for user-specific health data indicating a time of first diagnosis of epilepsy and a time of last diagnosed epilepsy attack, and in case of detecting a diagnosed epilepsy attack within the last 12 month, in a second tree structure a request for user-specific health data indicating a hospital stay caused by a diagnosed epilepsy attack and/or a number of epilepsy attacks within the last 12 month and/or at least one grand mal epilepsy attack.

As a further embodiment variant, the capturing of the medical parameter data set and the supplement medial response process can e.g. be realized supporting IDC (International Data Corporation) integration. The IDC integration can be provided by a communication plugin of the automated UW system 1 allowing a seamless integration of the UW system 1 into any third party web-sides or the like. As the IDC supplies content for the UW questionnaires, appropriate styling capabilities so provided allows to make integration absolutely seamless for the end user, while taking full advantage of IDC business logic functionality. The inventive system 1 does not require/produce medical evidence costs or manual underwriting referrals. For most risk assessments (90-95%), the simplified process provides a good enough decision, though using only simple clinical data the applicants typically know about themselves. If a main disorder is indicated by the captured data, the solution uses only 2-3 simple further questions per main disorder and no precise diagnosis is needed. Compared to other more complex rule-based UW solutions and processes, the invention is based on only approximately 100 rules, while the more, prior art complex systems, typically need to rely on approximately 2500 rules and more.

As a further variant, the inventive system 1 further comprises a built in dynamic adaption process. In technical real-world applications, before a classifier (as the inventive electronic signal processing engine 11 and its decision-tree based classifier structure) in a production environment can be used, the classifier's entire lifecycle should be addressed from its structure and implementation to its validation, tuning, production testing, use, monitoring, and maintenance. The term “maintenance” denotes all the steps required to keep the classifier vital (e.g. non-obsolete) and able to adapt to changes. Two technical reasons justify a focus on maintenance. Over the lifecycle of the classifier, maintenance costs are typically the most expensive component. Secondly, when dealing with mission-critical processing, continuous operations or at least fast recovery from system failures must be ensured to avoid incurring a loss of revenue and other costs. An obsolete classifier is as useful as one that can no longer run under a changed environment of the operating system.

Regarding the historical database, the important task is to gather data that mirror possibly most of the real world and thus can be used to create the decision-tree-based structure, and to verify that the boundary conditions, as required R² is met. Data is critical to the decision-tree-based structure process and for the decision engine (i.e. the electronic signal processing engine 11), respectively, because these data is critical for the decision/modeling structure (which can be seen simply as a transfer function from X's to Y's, the X's being the decision engine inputs and the Y's being the decision engine outputs). Technically, there is no other way to test and validate a decisioning structures than by applying data. For the inventive system 1, it is important to try to capture all the critical X's for the decision-making. The widest set of X's can e.g. be taken for the process, which in the present case e.g. comprised more than 11'000 medical event datasets. Next, one must ensure completeness of the data and homogeneity of digital format. For example the answers to these questions can expose gaps in the historical database. If not all of these required X's were digitally available, e.g. a data gathering process can be used. This can involve taking a random sample of historical cases, having the relevant data from those cases entered into a temporary database to be used for extracting the risk shape pattern needed to provide the decision-tree-based structure. In addition to the X's to be used as inputs to the electronic signal processing engine 11, historical decisions (Y's) on these cases can be used to allow learning and classifying the extracted risk shape patterns which is technical critical for development of the electronic signal processing engine 11. Regarding the historical database as initial medical event datasets, it is never possible to predict, beforehand, what the data needs will be. To solve that problem, a multi-phase approach can e.g. be taken. Thus, the historical medical event dataset can e.g. be assessed using data mining techniques such as Classification and Regression Trees to determine the relevance of each X gathered, as a predictor of the final decision. This can yield several key findings. First, none of the X's could be eliminated right away as being irrelevant. Second, certain types of medical event case can be under-represented in the historical data, particularly those that, although within the engine's defined scope, are placed into worse risk categories (i.e. higher risk-transfer premiums, closer to standard rates). Third, since these data would be fundamental to the measurement system 1 to validate that the critical technical requirements are met, a measurement system analysis has to be to confirm its ability to accurately measure the performance of the engine 11.

The first issue is simple to accommodate: in the initial engine designs, all X's can e.g. be incorporated by generating appropriate generic linking rules and questions. The second issue can be addressed in a next round of data collection. A stratified random sample can e.g. used to include those cases that are detected by the system 1 to be under-represented in the historical database (i.e. the initial 11'000 medial event datasets). Since the resulting sample would not be representative of the population of incoming applicants, the resulting performance metrics on the automated decision engine will not be representative of this population either. To overcome this problem, the performance metrics can technically be measured on each stratum separately. The expected performance on the incoming population would be assessed utilizing the population proportion of the strata to reweigh the importance of each stratum in the sample.

For the third issue, for example, an experienced underwriters can conduct a blind review of a sample of cases from the database and arrive at a ‘consensus’ decision for each case. The resulting dataset can serve as the benchmark decisions against which the decisions of both the engine and the current underwriting process can be independently compared. Without such a process, there is technically no way to measure the accuracy of the automated decision engine 11. Further, a cross-validation approach can e.g. be used in which the full data set e.g. is divided into multiple segments, with each segment being used to validate the accuracy of the automated decision engine 11 based on the other segments.

As a final point about the historical database and a possible data collection process, the additional set of X's, which are not digitally captured from the historical database, can e.g. be documented and supplied back to the system 1. It should be clear exactly what data the decision engine 11 will need for a proper learning phase and/or proper extraction of linking rules and linking questions, any range restrictions or cross checks to be applied, etc. These issues are interface issues. The point to understand is that the decision engine 11 can always be used as part of the larger UW system 1 and/or a risk-transfer system comprising the UW system 1. This system is the entity that can actually produce or use decision results. The decision engine 11 may be an important, even critical, component in such a system, but it does not “stand alone”. It has no value until it is technically integrated within such an automated system and the system as a whole is performing and producing results. By keeping this technical “system view” in mind while developing the decision engine 11, the interface issues are more likely to get the deeper attention.

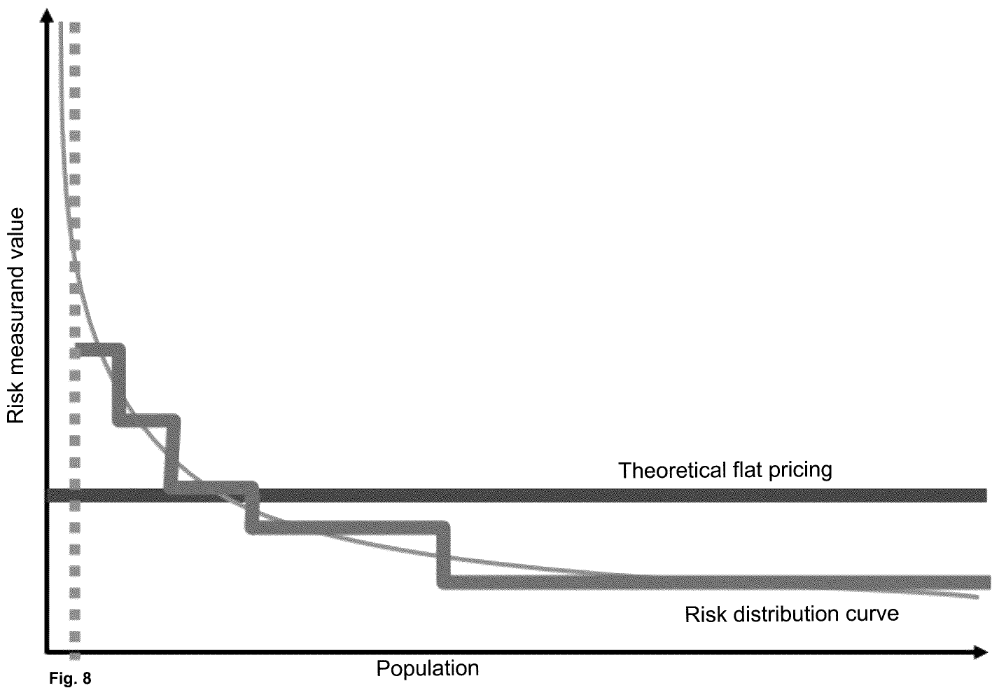

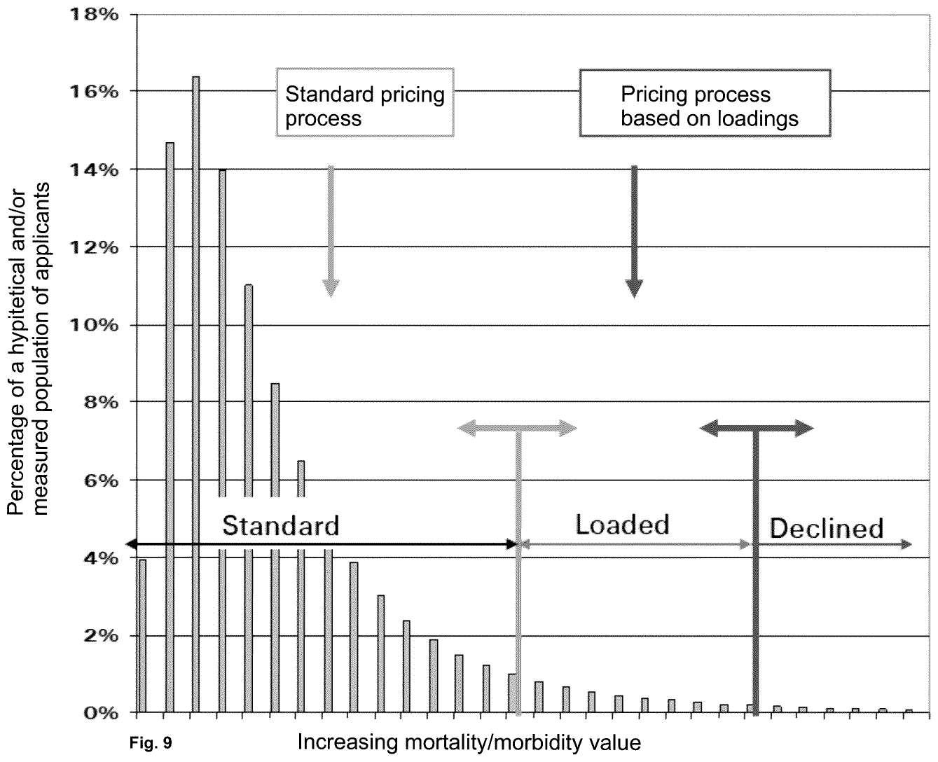

Regarding the pricing engine of the inventive system 1, such a pricing engine can e.g. comprise an automated matching and assigning process of a detected and clustered risk shape to pricing parameter values. FIG. 8 articulates and illustrates the automated pricing process of the underwriting process and the technical role of the UW system 1 to automatically match, as closely as possible, a variably adjusted pricing to an applicant's risk (bottom axis is worst to best risks). It is to be noted that there will always be a small percentage who is not applicable by underwriting at an affordable price (those let of the dotted line). The theoretical flat pricing is not relevant for voluntary risk-transfers but would be for an obligatory social type of risk-transfer, where there is no choice of purchase. FIG. 9 shows a diagram illustrating the same process as FIG. 8, however, in a different way, with typically standard pricing processes defining the standard price based on fixed risk factors (age, policy type, term, etc.) and an extended underwriting process assessing each applicant/individual to identify if they qualify for that standard pricing based on individual variables (primarily personal medical history or state of health) specific for a certain extended underwriting process. These so-called loadings are typically based on relative risk values to the defined standard price of the standard pricing process, so e.g. a standard price might be X, but a loaded premium could be 2 times X, or 3.5 times X, but the same multiple might be applied for many different medical conditions, e.g. 2 times X might be due to any of obesity, hepatitis or high blood pressure (for example). This processing in multiple of standard pricing, typically called “extra mortality” for life risk-transfer/insurance structures, forms the basis of how the inventive system 1 can, for example, be realized to automatedly assessing those additional medical risks; the system 1 captures each applicant's input/disclosure and identifies if that disclosure is a not important factor which can be immediately placed into the standard price category, or the system 1 identifies disclosures which might be of higher risk values and requests input to reflex questions to identify the most appropriate risk category, including still standard, or also multiples of standard or even declinature in some cases if the risk value is detected to be too high to be insurable. Some medical conditions require very specific linking questions to quantify the level of additional risk, i.e. to cluster it to the correct risk shape, such as obesity which is driven primarily based on current height and weight, and these would have bespoke rules built into to present inventive system 1. Related disease pattern can often be grouped/clustered together, for example, very differing moderate blood disorders, such as hemophilia and thrombocythemia, which if not awaiting investigations or hospital treatment show a relatively fixed extra mortality multiple. But beyond this, other, even very different, conditions can have their level of additional risk quantified using the same reflex linking questions. An example of a common linking rule for differing conditions might be rabies and an unexplained syncope (faint), both of which can be assessed in the same manner, with a short postpone period followed by standard rates if fully recovered.

For the inventive pricing engine and pricing process, it is to be emphasize, that the concept of a risk-transfer system is to create a pool of resources such that an unfortunate loss incurred by the few can be compensated by the pooled resources of the many. It is clear that the technical success of the automation this concept relies on accuracy of the system to make the distinction between the few, those deemed to have a high chance of claiming, and the many, those deemed to have a low chance of claiming. This automated process of providing output signaling of such decisions is called automated underwriting.

One of the technical goals and objects of automated underwriting from the perspective of the risk-transfer system is to accurately assess or measure the risk posed by individual applicants, where risk in life/health insurance can be considered as the measurable likelihood of an injury, sickness, disease, disability or mortality impacting an applicant. A direct output of the automated underwriting process is the decision signaling to accept or decline an applicant's access into the risk-transfer pool and what resources and/or monetary cost parameters should be determined in exchange for access and in order to ensure ongoing operation of the risk-transfer system. Most applicants can be priced by a standard pricing process (see FIG. 9) for granting access to the risk-transfer system, but some may require a penalty, known as a loading (see FIG. 9), that should ideally reflect the measured level of risk they pose and their likelihood of claiming. In addition to a loading, an applicant may, as an embodiment variant, be granted special access to the risk-transfer system but with certain claiming constraints associated with the access, known as an exclusion. An exclusion can e.g. be applied by the system to prevent a specific applicant claiming as a result of a particular event, back injury for example, but still allowing them access to the risk-transfer system and rights to claim for other events they are not excluded from. Correctly identifying risks and applying the relevant loadings and exclusions during the underwriting process is technically fundamental to maintaining the resources (and thus operation) of an automated life/health risk-transfer system. In the mostly manual prior art processes, underwriting is a tedious and labor intensive process on behalf of both the applicant and the underwriter. An applicant must fill out a highly personal questionnaire that delves into almost all aspects of their life which can be up to or even over 2500 questions, an imposing amount of paperwork that can turn applicants off pursuing risk-transfer cover. Further in the prior art, in addition to being tedious on behalf of the applicant, the questionnaires typically must be closely examined by a team of skilled underwriters who must follow guidelines mixed with intuition to arrive at a decision, resulting in a process that takes many weeks to complete. The mixture of guidelines and intuition is a known problem in the risk-transfer industry. There is a need to improve the quantitative methods that make up a technical basis of the underwriting process in order to maintain the relevancy of the industry. The inventive automated UW system 1 with the disclosed inventive efficient, automated UW process and automated pricing process based on the linking and clustering of medical events with similar risk shape patterns, does not show these technical problems. As a further embodiment variant, apart from the automated process, inter alia illustrated by FIGS. 8 and 9, machine learning and pattern recognition can be applied to improve the decision making process.

The inventive automated UW system 1 provides a complete automation of the underwriting process which has technical advantages in a number of ways and technical benefit to all parties involved. Timeliness of the underwriting process can be improved significantly; instances of human error can be reduced and misunderstandings or knowledge gaps in the underwriters can be filled. The current underwriting completion time frame of weeks can be reduced significantly with the assistance of the present inventive automated decision making system 1. Most applications go through the underwriting process with no exclusion or loading applied, underwriters spend a lot of time dealing with these cases that could be streamlined and allow that time to be spent focusing on the more complex cases. In fact, some prior art rule-based expert systems have been designed to identify and process these simple applications, but they are complex and technically cumbersome to update in light of new information and changing environmental conditions. Further in the prior art systems, the detail covered by the thousands of questions within the questionnaire requires a considerably deep and wide knowledge base to be able to deeply understand the answers and the implications for risk measurands. In addition to gaining a thorough understanding of these numerous knowledge areas, an ambitious task alone, there is, in the prior art, the added difficulty of being able to identify the complex relationships between the diverse knowledge areas and how they can be used to forecast risk. The use of the present invention is further able to provide and assist an underwriter in increasing their knowledge base and identifying these complex relationships, which cannot be achieved by the known prior art systems

### LIST OF REFERENCE SIGNS

1 Digital UW system
10 Data Store
101, . . . , 105 Modular Digital Assets/Objects Data Elements
11 Signal processing engine
12 I/O Devices (input devices and sensors)
121 Measuring or capturing devices
122 Data interfaces
13 Electronic underwriting unit
3 Real-world Object
31 Physical Object
331 Human Being
332 Animal
34 Subsystems of the Real-world Asset or Object
341, 342, 343, . . . , 34i Subsystems 1, . . . , i
35 Subsystems and Components of the Ecosystem
351, 352, 353, . . . , 35i Subsystems 1, . . . , i

1. A digital, automated underwriting (UW) system with a fast point of sale decision-making and smart data processing engine realized as an optimized, comprising:
processing circuitry configured to
implement a decision-tree-based electronic signal processing engine that uses a smart decision-tree structure to automate the assessment of an applicant's risk shape profile used for an automated risk-transfer underwriting for the coverage of possible damages impacted by the occurrence of one or more medical events to an applicant, wherein the coverage is provided by applying a risk-transfer structure of an associated risk-transfer system to the applicant, wherein user-specific medical parameter data sets are captured and/or measured by associated capturing or measuring devices via data interfaces of the automated UW system, and wherein each captured medical parameter data set is processed by the electronic signal processing engine, the electronic signal processing engine transmitting an output signal generated upon processing the medical parameter data set by decision-tree-based structure, and the output signal automatically triggering or blocking an automated application of the risk-transfer structure upon electronic signal transfer to the risk-transfer system,
cluster and link together medical events of a historical event database having a similar risk shape pattern, wherein similarity of risk shape pattern is given if the risk shape pattern of said medical events are detected to be within a defined maximal topological distance within a parameter space given by a medical parameter datasets of a medical event, a cluster of medical events of a historical event database having similar risk shape pattern for all medical events of the same cluster comprising related and/or unrelated medical event, wherein unrelated medical events at least comprise medical events with unrelated clinical pictures and/or unrelated medical causes,
extract risk shape pattern at least based on occurrence frequency and impact severity measured based on measured occurrences of the medical events of the historical database,
provide the linking of medical events of said historical event database to a same cluster by a set of linking rules and/or linking questions forming the decision-tree-based data processing structure of the electronic signal processing engine, wherein a decision distribution given by outputted decisions provided by applying the decision-tree-based data processing structure electronic signal processing engine represents the frequency of medical events measured to be within the same cluster of risk shape pattern,
by detecting newly occurring medical events not culsterable by the electronic signal processing engine and its set of linking rules and/or linking questions of the decision-tree-based data processing structure, due to a missing similarity to existing risk shapes, generate and add additional linking rules and/or linking questions dedicated to capture and cluster the newly occurring medical events to the set of linking rules and/or linking questions, and
adapt the number of linking rules and/or linking questions of the set until a minimal set of linking rules and/or linking questions capture a predefined percentage of processed medical parameter data set with an output signal that automatically triggers the automated application of the risk-transfer structure of the risk-transfer system, wherein the predefined percentage is equal or above 65% of the processed medical parameter data set.

2. The digital, automated underwriting (UW) system with an optimized, decision-tree-based electronic signal processing engine according to claim 1, wherein the predefined percentage is equal or above 95% of the processed medical parameter data set.

3. The digital, automated underwriting (UW) system with an optimized, decision-tree-based electronic signal processing engine according to claim 1, wherein a cluster of medical events of a historical event database having a similar risk shape pattern comprise related and/or unrelated medical event, wherein unrelated medical events at least comprise medical events with unrelated clinical pictures and/or unrelated medical causes.

4. The digital, automated underwriting (UW) system with an optimized, decision-tree-based electronic signal processing engine according to claim 1, wherein by detecting and/or measuring newly occurring medical events not culsterable by the set of linking rules and/or linking questions of the decision-tree-based data processing structure due to a missing similarity to existing risk shapes, additional linking rules and/or linking questions dedicated to capture and cluster the newly occurring medical events are generated and added to the set of linking rules and/or linking questions.

5. The digital, automated underwriting (UW) system with an efficient, decision-tree based electronic signal processing engine according to claim 1, wherein the signal processing engine provides fast point of sale decision-making based on an adaptive data capturing.

6. The digital, automated underwriting (UW) system with an optimized, decision-tree-based electronic signal processing engine according to claim 1, wherein the decision-tree structure comprises first level branches applied during data processing by the signal processing engine encompassing a threefold rule-based triage-process, the medical parameter data sets being triaged by applying a first rule-based trigger triggering off a first trigger-flag upon detection of medical parameter values in a processed medical parameter data set indicating an predicted damage to the user based on an occurrence of heart disease event, cancer event or diabetes event, and by applying a second rule-based trigger triggering off a second trigger-flag upon detection of medical parameter values in the processed medical parameter data set indicating an occurrence of two or more consecutive weeks off work due to sickness or injury in the past 12 months, and by applying a third rule-based trigger triggering off a third trigger-flag upon detection of medical parameter values in the medical parameter data set indicating an admission of the individual to a hospital at any time in the past two years, and
upon detecting that none of the three trigger-flags being triggered by the system, the processed medical parameter data set is assigned to the automated underwriting process by generating and transmitting the output signal by the electronic signal processing engine to the electronic underwriting unit of the digital UW system, the output signal automatically triggering the automated underwriting process of the electronic underwriting unit, and
upon detecting that at least one the three trigger-flags being triggered by the system, the triggering of the automated underwriting process is rejected by the system at the first level branches of the applied decision-tree structure for the processed medical parameter data set.

7. The digital, automated underwriting (UW) system according to claim 6, wherein second level branches of the applied decision-tree structure are applied by the signal processing engine to a processed medical parameter data set, if the triggering of the automated underwriting process is rejected by the system for said processed medical parameter data set, and
the second level branches are driven by a supplement medial response process, the supplement medial response process comprising capturing of a limit set of user-specific health data detailing out the processed medical parameter data set based on the possible indications of at least heart disease and/or cancer and/or diabetes and/or epilepsy.

8. The digital, automated underwriting (UW) system according to claim 7, wherein the limited set of user-specific health data are captured by an intelligent hierarchical input tree adapting subsequent of user-specific health data request based on user-specific health data precedingly captured.

9. The digital, automated underwriting (UW) system according to claim 8, wherein in case of detecting an indication of epilepsy in a processed medical parameter data set, the intelligent hierarchical input tree comprises in a first tree structure a request for user-specific health data indicating a time of first diagnosis of epilepsy and a time of last diagnosed epilepsy attack, and
in case of detecting a diagnosed epilepsy attack within the last 12 month, in a second tree structure a request for user-specific health data indicating a hospital stay caused by a diagnosed epilepsy attack and/or a number of epilepsy attacks within the last 12 month and/or at least one grand mal epilepsy attack.

10. The digital, automated underwriting (UW) system according to claim 7, wherein the capturing of the medical parameter data set and the supplement medial response process are realized supporting IDC integration.

11. The digital, automated underwriting (UW) system according to claim 6, wherein the UW system comprises machine-learning based process for developing a user-specific damage modelling structure for automated forecasting of future health damage measures, wherein an automated forecast of a future health damage measures is for an actual or future time period, comprising the steps of:
providing development of a dynamically adapted integral database based comprising user-specific underwriting data and historical health care claims data, where the historical health care claims data comprises at least a claim code and a claim amount;
providing at least one forecasted damage factor for each historical base period claim based on the claim code associated with the health care claim value and providing at least one forecasted damage factor based on the underwriting data; and
developing the user-specific damage modelling structure simulating a predictive impact measure of a damage associated with the occurrence of the health event to the user based on the dynamically adapted integral database through the application of an interaction capturing technique to the dynamically adapted integral database.

12. The digital, automated underwriting (UW) system according to claim 11, wherein the machine-learning based process comprises at least one interaction capturing technique selected from a group consisting of median regression tree techniques and/or least square regression tree techniques and/or rule induction techniques and/or ordinary least squares regression techniques and/or median regression techniques and/or robust regression techniques and/or genetic algorithms, rule induction and/or clustering techniques and/or neural network techniques.

13. The digital, automated underwriting (UW) system according to claim 11, wherein values of the future health damage measures are simulated by modifying an extant cost forecast value by simulating expected cost trend values.

14. The digital, automated underwriting (UW) system according to claim 12, wherein the datum from historical claims used as predictors consist essentially of the claim- and underwriting-based probability factors, wherein a damage amount value is a standardized cost value of health services provided, and wherein prospective payments are allocated to health care providers by the user-specific damage modelling structure.

15. The digital, automated underwriting (UW) system according to claim 11, wherein data from the historical health care claims data used as input the user-specific damage modelling structure comprise essentially the claim code and selected mandatory procedures, wherein a claim amount value is measured as a standardized cost value of health services provided during the same time period as a base period and wherein an efficiency factor of health care providers is generated by the user-specific damage modelling structure.

16. The digital, automated underwriting (UW) system according to claim 15, wherein the forecasted future health damage measures only comprise damage measures attributable to claims from a user.

17. The digital, automated underwriting (UW) system according to claim 15, wherein the actual or future time period is associated with a defined term of a risk-transfer between the user and an automated risk-transfer system, the automated risk-transfer system covering a probability of the occurrence of a damage impact to the user in return of accumulating resources of a plurality of users.

18. The digital, automated underwriting (UW) system according to claim 1, wherein the implemented process includes developing a user-specific cost structure providing forecasted future cost values attributable to historical claims, where user-specific data regarding actual base period health care claims are available for a user for an actual underwriting period, and a future claim amount value is for an actual risk-transfer period.

19. A method, implemented by processing circuitry of a digital, automated underwriting (UW) system with a fast point of sale decision-making and smart data processing engine realized as an optimized, comprising:
implementing a decision-tree-based electronic signal processing engine that uses a smart decision-tree structure to automate the assessment of an applicant's risk shape profile used for an automated risk-transfer underwriting for the coverage of possible damages impacted by the occurrence of one or more medical events to an applicant, wherein the coverage is provided by applying a risk-transfer structure of an associated risk-transfer system to the applicant, wherein user-specific medical parameter data sets are captured and/or measured by associated capturing or measuring devices via data interfaces of the automated UW system, and wherein each captured medical parameter data set is processed by the electronic signal processing engine, the electronic signal processing engine transmitting an output signal generated upon processing the medical parameter data set by decision-tree-based structure, and the output signal automatically triggering or blocking an automated application of the risk-transfer structure upon electronic signal transfer to the risk-transfer system, clustering and linking together medical events of a historical event database having a similar risk shape pattern, wherein similarity of risk shape pattern is given if the risk shape pattern of said medical events are detected to be within a defined maximal topological distance within a parameter space given by a medical parameter datasets of a medical event, a cluster of medical events of a historical event database having similar risk shape pattern for all medical events of the same cluster comprising related and/or unrelated medical event, wherein unrelated medical events at least comprise medical events with unrelated clinical pictures and/or unrelated medical causes,
extracting risk shape pattern at least based on occurrence frequency and impact severity measured based on measured occurrences of the medical events of the historical database,
providing the linking of medical events of said historical event database to a same cluster by a set of linking rules and/or linking questions forming the decision-tree-based data processing structure of the electronic signal processing engine, wherein a decision distribution given by outputted decisions provided by applying the decision-tree-based data processing structure electronic signal processing engine represents the frequency of medical events measured to be within the same cluster of risk shape pattern,
by detecting newly occurring medical events not culsterable by the electronic signal processing engine and its set of linking rules and/or linking questions of the decision-tree-based data processing structure, due to a missing similarity to existing risk shapes, generating and adding additional linking rules and/or linking questions dedicated to capture and cluster the newly occurring medical events to the set of linking rules and/or linking questions, and
adapting the number of linking rules and/or linking questions of the set until a minimal set of linking rules and/or linking questions capture a predefined percentage of processed medical parameter data set with an output signal that automatically triggers the automated application of the risk-transfer structure of the risk-transfer system, wherein the predefined percentage is equal or above 65% of the processed medical parameter data set.
